(19) United States
(12) Patent Application Publication
(10) Pub. No.: US 2003/0087623 A1
(43) Pub. Date: May 8, 2003

(54) Mixer circuit having a preamplifier

(75) Inventor: Klaus Solbach, Muelheim (DE)

Correspondence Address: CROWELL & MORING LLP, INTELLECTUAL PROPERTY GROUP, P.O. BOX 14300, WASHINGTON, DC, 20044-4300, US

(73) Assignee: Dornier GmbH

(21) Appl. No.: 10/289,428

(22) Filed: Nov. 7, 2002

(30) Foreign Application Priority Data
Nov. 8, 2001 (DE) 101 54 995.4

(51) Int. Cl. H04B 1/26

(52) U.S. Cl. 455/318; 455/323; 455/313

(57) ABSTRACT

A mixer circuit including a mixer (MIX) for mixing the RF signal supplied to the mixer (MIX) and reinforced in a preamplifier (LNA) with an LO signal supplied to the mixer (MIX). A line (L1) common to the RF signal and the LO signal is connected with the input of the preamplifier (LNA). In addition, there is another line (L2) which the RF signal and the LO signal have in common, and which connects the output of the preamplifier (LNA) with the input of the mixer (MIX), the level of the LO signal being below the compression point of the preamplifier (LNA).

### BACKGROUND AND SUMMARY OF THE INVENTION

This application claims the priority of Application No. 101 54 995.4, filed Nov. 8, 2001, in Germany, the disclosure of which is expressly incorporated by reference herein.

The invention relates to a mixer circuit having a preamplifier with a reduced number of stages.

In high-frequency engineering, received signals, coming, for example, from receiving antennas, are shifted from their original frequency range, for example, radio frequency (RF) or high frequency (HF), into another frequency range, also called “intermediate frequency” (IF), in order to be processed. This shift takes place in a mixer which combines the RF signal and a local oscillator signal (LO signal). The intermediate frequency signal generated thereby has two components of the frequencies f_{LO}+f_{RF} and f_{LO}−f_{RF}.

Such mixers are normally operated as passive mixers or active mixers with semiconductor devices (diodes and transistors) being used in the circuits.

In known mixer circuits, the RF signal and the LO signal are supplied to the mixer on different paths, the RF signal being amplified (FIG. 1) in a preamplifier, normally a Low Noise Amplifier (LNA). In this case, the LO signal has a level required for the operation of the mixer.

When the mixer is constructed as a so-called unbalanced mixer, it normally designed such that the LO signal and the RF signal are combined on a common line and are supplied to the semiconductor device (FIG. 2). Here, directional couplers or network elements without any frequency filtering (diplexer filter) are normally used. In this case, the RF signal can be transmitted with a low transmission loss through the mixer only when the coupling of the LO signal is weak; that is, the directional coupler RK (network element) has a high coupling attenuation. A high LO signal power is therefore required at the input of the directional coupler or network element. This increase of the power requirement is normally met by additional amplifier stages which are normally integrated in the LO modules.

In array antennas with several receiver channels and several mixer circuits, it was found to be disadvantageous that, because of the high signal power requirement, several amplifier stages are necessary, which results in considerable constructional expenditures and is very cost-intensive.

Additional circuits with mixers are known, in which case the mixers remote from a supply station are supplied with RF and LO signal by way of lines. Such mixer circuits are used, for example, in phased-array antenna systems with transmit-receive modules and optical transmission (fiberglass line) of the signals. Here, it is found to be disadvantageous that either two separate lines for the LO and RF signal must be guided or, when a common line is used, a frequency diplexer has to be used for the separation, which is very difficult and requires high expenditures particularly in the case of a low frequency spacing (FIG. 3). In addition, mainly in fiber-optical transmission systems, the levels of both signals have to raised by one preamplifier respectively, which also leads to considerable constructional expenditures.

It is an object of the invention to provide a mixer circuit at low constructional expenditures and a reduced number of required amplifier stages.

According to the invention, a common line exists for the RF signal and the LO signal, which common line is connected with the input of the preamplifier. Furthermore, according to the invention, another line is present, which the RF signal and the LO signal have in common and which connects the output of the preamplifier with the input of the mixer with the level of the LO signal being below the compression point of the preamplifier.

At the output of the advantageously low-noise preamplifier, the LO signal level is therefore raised to the level required for the operation of the mixer which advantageously is an active mixer. In this case, the mixer is also called an “unbalanced” mixer. It is advantageous in this case that the level required at the input of the preamplifier is lower by a factor determined by the power amplification of the preamplifier. As a result, the constructional expenditures are considerably reduced because fewer amplifier stages are required. Furthermore, when the mixer circuit according to the invention is used in array antennas with several mixer circuits with a corresponding power demand, the number of the required amplifier stages can be reduced.

The RF signal and the LO signal are amplified in the common preamplifier without serious losses in the gain, the noise figure and the dynamic range. According to the invention, the level of the LO signal, which normally has a higher lever than the RF signal, is clearly below the compression point of the preamplifier. In this case, the compression point is that point at which the real transfer characteristic of the amplifier starts to deviate from the ideal transfer characteristic of the amplifier. Starting from a defined input level, the amplifier will no longer supply a higher output level but will start saturation.

At the input of the preamplifier, the noise level of the LO signal is advantageously below the noise level of the RF signal.

The amplification of the RF and LO signal in a common preamplifier according to the invention, because of the low required LO signal power, is particularly suitable for the use in active mixers. However, it is also possible that the concept according to the invention can be used in other mixer circuits, such as passive mixers.

In suitable circuits, it is possible to reduce the noise level of the LO signal by filtering the LO signal.

In addition, it is possible to suppress the image frequency signals by means of filters, particularly steep-skirt filters, situated in the signal path in front of and/or behind the preamplifier.

Other objects, advantages and novel features of the present invention will become apparent from the following detailed description of the invention when considered in conjunction with the accompany drawings.

### BRIEF DESCRIPTION OF THE DRAWINGS

The invention as well as additional embodiments of the invention will be explained in detail by means of drawings.

FIG. 1 is a schematic of a mixer with a preamplifier according to the state of the art;

FIG. 2 is a schematic of an unbalanced active mixer which is shown as an example and has a directional coupler as an RF/LO diplexer according to the state of the art;

FIG. 3 is a schematic of a remote mixer with a supply station and a frequency diplexer according to the state of the art;

FIG. 4 is a schematic of a mixer circuit according to the invention having a preamplifier for amplifying the LO signal and the RF signal;

FIG. 5 is a schematic of an advantageous embodiment of the mixer circuit according to the invention having a preamplifier for amplifying the LO signal and the RF signal;

FIG. 6 is a schematic of an advantageous mixer circuit with a supply station and a remote mixer.

### DETAILED DESCRIPTION OF THE DRAWINGS

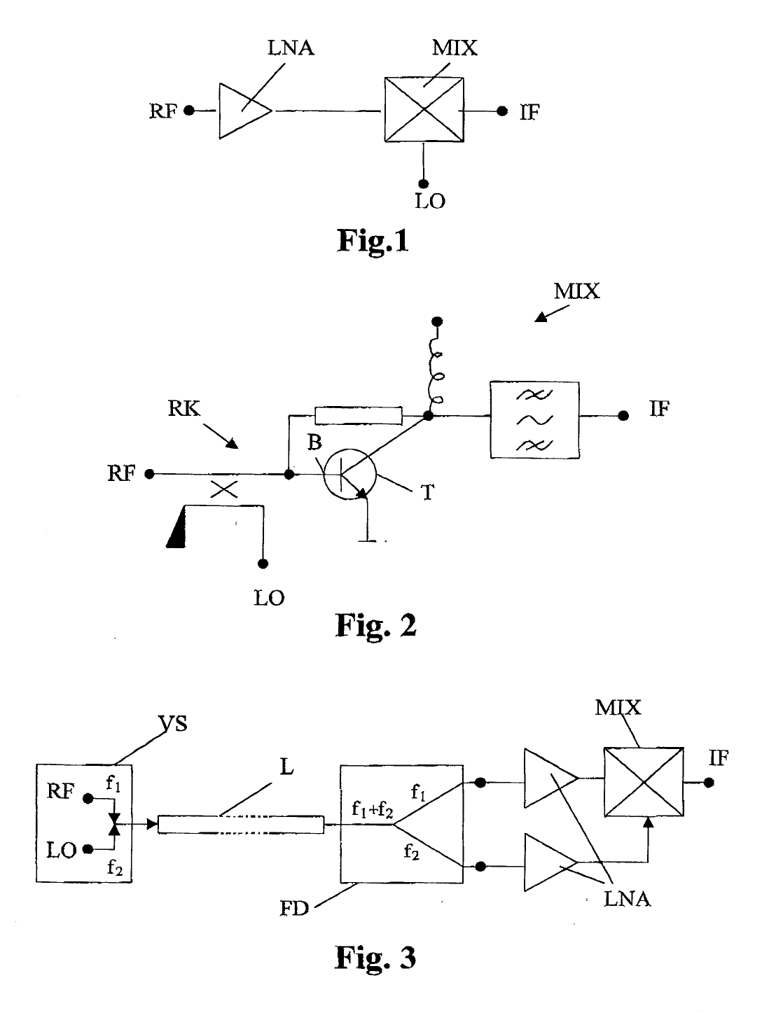

FIG. 1 illustrates a mixer having a preamplification according to the state of the art. In this case, the mixer MIX has two inputs by which the RF signal and the LO signal are supplied to the mixer. At the output of the mixer MIX, the intermediate signal IF is generated. An input of the mixer MIX for the RF signal is in this case connected with the output of the preamplifier LNA whose input is fed with the RF signal of the receiving antenna (not shown). The other input of the mixer MIX is fed with the LO signal.

As an example, FIG. 2 illustrates an unbalanced active mixer with a directional coupler as an RF/LO diplexer according to the state of the art. In this case, a transistor T is fed on its base B by way of a directional coupler RK which combines the RF signal and the LO signal on a common line (diplexer). This circuit principle is also called additive mixing.

FIG. 3 shows a mixer circuit with a mixer remote from a supply station according to the state of the art. In the supply station VS, the LO and RF signals with the frequencies f₁ and f₂ are combined and are fed by way of a line L into a frequency diplexer FD. In the frequency diplexer, a separation of the signals and thus of the frequencies f₁ and f₂ to two lines takes place. Each signal is guided in one line respectively and is supplied to one amplifier stage respectively in which the respective signal is amplified. Subsequently, the amplified signals are each supplied to a separate input in the mixer MIX.

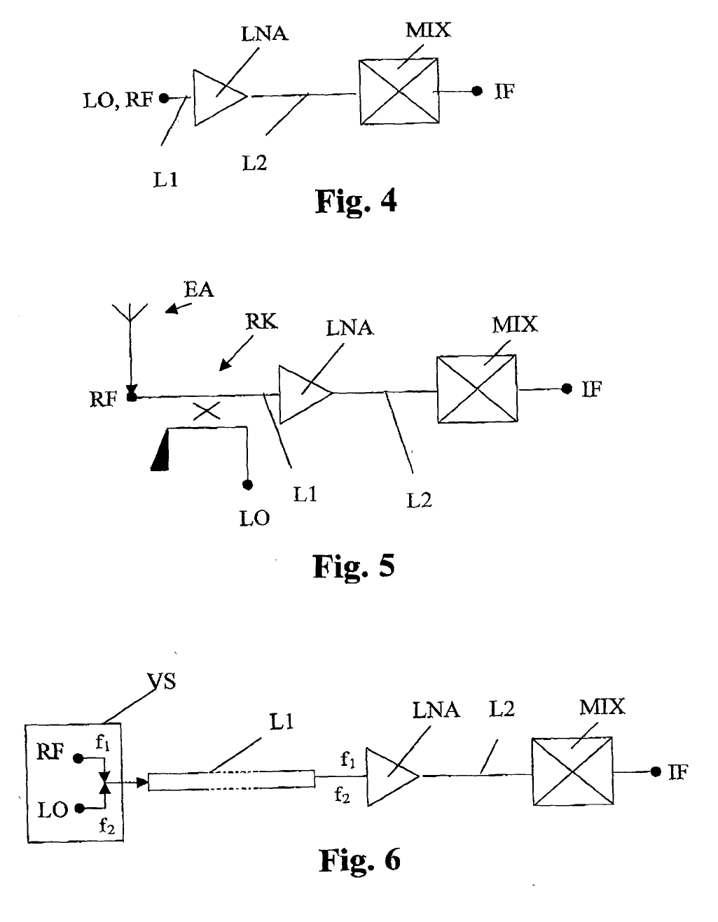

FIG. 4 illustrates a mixer circuit according to the invention which has a preamplifier to which the RF and the LO signals are supplied on a common line. The input of the preamplifier LNA is fed by way of an individual line L1 with the RF and LO signal. The output of the preamplifier LNA is connected by the line L2 with an input of the mixer MIX. The output of the mixer MIX supplies the intermediate signal IF. The circuit according to the invention shows that here only a single preamplifier LNA is required for the amplification of the RF and LO signal. In addition, the two signals are fed on a respectively common line L1 and L2 to the preamplifier LNA and to the mixer MIX.

FIG. 5 shows an advantageous embodiment of the receiver circuit according to the invention having a single preamplifier for amplifying the RF and LO signal. A directional coupler RK is situated in the signal path in front of the single preamplifier LNA. In the directional coupler RK, the RF signal, which comes, for example, from a receiving antenna EA, and the LO are combined on a common line L1. This line 1 is guided to the input of the preamplifier LNA. The output of the preamplifier LNA is connected by way of another line L2 with the input of the mixer MIX, at whose output the intermediate frequency IF is generated.

In this embodiment, the directional coupler is used as the diplexer. However, other advantageous diplexer constructions may also be used, such a capacitive couplers, line branchings, bridge circuits, transformers or filter diplexers.

FIG. 6 shows an advantageous mixer circuit with a supply station and a remote mixer. In the supply station VS, as explained in connection with FIG. 3, the RF signal and the LO signal are combined on a common line L. This line L1 is connected with an input of a preamplifier LNA which amplifies the RF signal and the LO signal. Another line L2 connects the output of the preamplifier LNA with an input of the mixer MIX. At the output of the mixer MIX, the intermediate frequency IF is generated.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A mixer circuit arrangement comprising:
a mixer for mixing a radio frequency (RF) signal with a local oscillator (LO) signal and providing an intermediate signal;
a preamplifier for amplifying said radio frequency signal;
a first common line supplied with said radio frequency (RF) signal and said local oscillator (LO) signal with an output end of said first common line connected to an input of said preamplifier; and
a second common line connected to an output of said preamplifier with an output end of said second common line providing an input signal to said mixer.

2. The mixer circuit arrangement to claim 1, further including a diplexer (RK) which combines the RF signal and the LO signal to the first common line (L1) and which is connected with the input of the preamplifier (LNA).

3. The mixer circuit arrangement according to claim 1, further including a supply station (S) remote from the mixer (MIX), said supply station combines the RF signal and the LO signal in said first common line (L1).

4. The mixer circuit arrangement according to claim 2, wherein the diplexer (RK) includes a directional coupler, a capacitive coupler, a line branching, a bridge circuit, a transmitter or a filter diplexer.

5. The mixer circuit arrangement according to claim 1, wherein the preamplifier (LNA) is a low-noise amplifier.

6. The mixer circuit arrangement according to claim 1, wherein the mixer is an off balance mixer.

7. The mixer circuit arrangement according to claim 1, wherein at the input of the preamplifier (LNA), the noise level of the LO signal is lower than the noise level of the RF signal.
